(19) United States
(12) Patent Application Publication
(10) Pub. No.: US 2012/0047771 A1
(43) Pub. Date: Mar. 1, 2012

(54) SPORT FOOTWEAR HAVING AN OUTSOLE IN COMPOSITE MATERIAL AND PROCESS FOR OBTAINING THE SAME

(75) Inventors: Arthur Steven Delacruz, Laguna Beach, CA (US); Claudio Checchin, Zelarino - Venezia (IT)

(73) Assignee: SELLE ROYAL S.P.A., Pozzoleone (IT)

(21) Appl. No.: 13/265,015

(22) PCT Filed: Apr. 30, 2009
(86) PCT No.: PCT/IB09/51759

§ 371 Date: Oct. 18, 2011

(51) Int. Cl. A43B 13/00; B29C 65/00

(52) U.S. Cl. 36/103; 156/245

(57) ABSTRACT

A sports footwear, particularly suitable for use in road and off-road bikes, including an outsole having means with differential stiffness, a heel cup made of at least a composite material with differential stiffness and a cushioning insert to be inserted into a padded tongue to achieve comfort and to customize said footwear, and a process to manufacture said footwear.

### BACKGROUND

1. Technical Field

The present invention relates to a sports footwear, which is particularly suited for use in bicycles and pedal vehicles of various kinds, both for road and off-road cycling, and more particularly, to a footwear that gives high comfort features, with an outsole and a heel cup of a composite material, having the ability to adjust the stiffness of the footwear thereof during the production, and a padded tongue with a cushioning insert to give a greater adjustment to the closure of the footwear and a greater comfort for the user.

Moreover, the present invention pertains to a process for obtaining said footwear providing a customizable output with respect to the stiffness of the footwear and modifiable at will on an ongoing basis by the manufacturer.

2. Description of Related Art

In the field of cycling footwear, various types of cycling footwear are known for use on different soils (road, mountain bike, track, and the like). In addition, said footwear is different on the basis of the type of pedal that is used/attached. For example, U.S. Pat. No. 5,943,795 discloses a type of footwear, for cycling clipless pedals, with a cleat fixedly coupled to the outsole for the pedal connection.

The U.S. Pat. No. 5,836,094 presents cycling footwear with a unified body in the form of a contoured foot that replaces the outsole and part of the upper portion of the footwear. This upper portion includes a tongue and adjustable straps to secure to the foot of the rider.

Furthermore, the cycling footwear outsoles are usually constructed from various materials—carbon fiber, carbon fiber composite, nylon/glass composite—and the outsole stiffness is manipulated by varying the material composition and orientation of fibers and/or layers of different materials.

However, it is necessary that cycling footwear firmly contains the user's foot during rides and/or effort, for example due to the characteristics of the soil, but at the same time guarantees the maximum comfort for the user.

In addition, usually considerable costs are incurred for instruments and equipment needed for the carbon fiber cycling footwear outsole production. Furthermore, the closure straps, having to be closely set to ensure the best possible foot containment, often produce pain and soreness to the user.

### SUMMARY OF THE INVENTION

One of the purposes of this invention is to improve the state of the art.

Another purpose of this invention is to provide footwear that allows the user to customize the fit according to his tastes and to the shape of his foot.

Another objective of invention is to have footwear with an outsole made of composite material having different stiffness characteristics to allow customization according to the weight of the user.

According to one aspect of this invention, these objects are solved by footwear as described herein.

Another object of this invention is to have footwear with a outsole that allows improved distribution of pressure forces on the foot, particularly at the heel.

Another purpose of this invention is to produce footwear which presents, in the area corresponding to the heel, a heel cup made of composite material that presents different stiffness characteristics.

Another purpose of this invention is to provide footwear having an elastic and flexible heel cup to allow the entry of the foot.

One purpose of this invention is to provide a heel cup that provides an excellent fit to a wide range of heels with different shapes and sizes.

Another purpose of this invention is to provide a heel cup which supports and controls the user's foot during athletic cycling to increase the power and effectiveness of the athletic cycling itself.

Another purpose of this invention is to provide footwear suitable for different foot conformations and sizes.

Another purpose of this invention is to provide footwear comprising a padded tongue with a cushioning insert to produce a high comfort level and to provide for the straps constrictions for user's foot support and control.

These and other purposes are resolved by preferred and advantageous embodiments of the invention as described herein.

Yet another object of this invention is to provide a process, for producing said footwear, that is customizable by the manufacturer, on a continuous basis and will, to change the stiffness and size of the footwear itself.

Another purpose of this invention is to provide a process for producing footwear suitable for different sizes and conformations of feet.

Another purpose of this invention is to provide a process in which it is not necessary to have new and/or diversified molds.

According to another aspect of this invention, a process for the production of footwear with an outsole and a heel cup is provided.

### BRIEF DESCRIPTION OF THE DRAWINGS

Additional features and advantages of this invention will become more apparent from the detailed description of footwear shown, by way of illustration and not of restriction, in the attached drawings in which:

FIG. 1 is a bottom view of the cycling footwear outsole;

FIG. 2 is a front cross section along axis I of the cycling footwear outsole referred to FIG. 1;

FIG. 3 is a cross section along axis L of the cycling footwear outsole referred to FIG. 1;

FIG. 4 is a side view of the outsole in accordance with an exemplary aspect of the present invention;

FIG. 5 is a top view of the footwear of the present invention;

FIG. 6 is a top view of the cushioning insert to be entered into the cycling footwear padded tongue; and

FIG. 7 is a side view of the cushioning insert referred to FIG. 6.

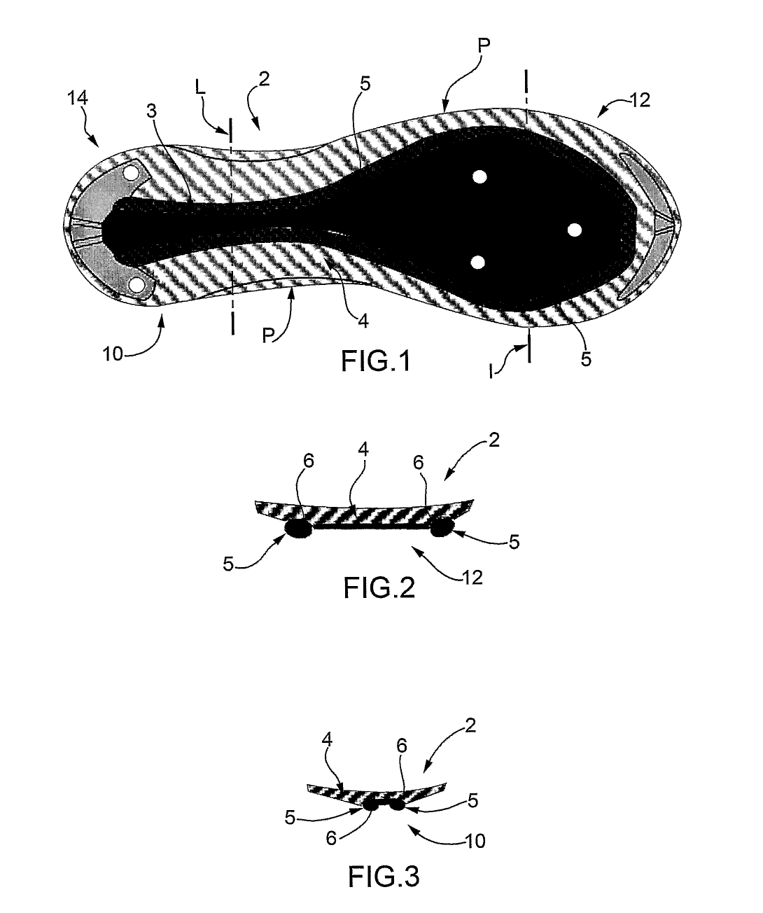

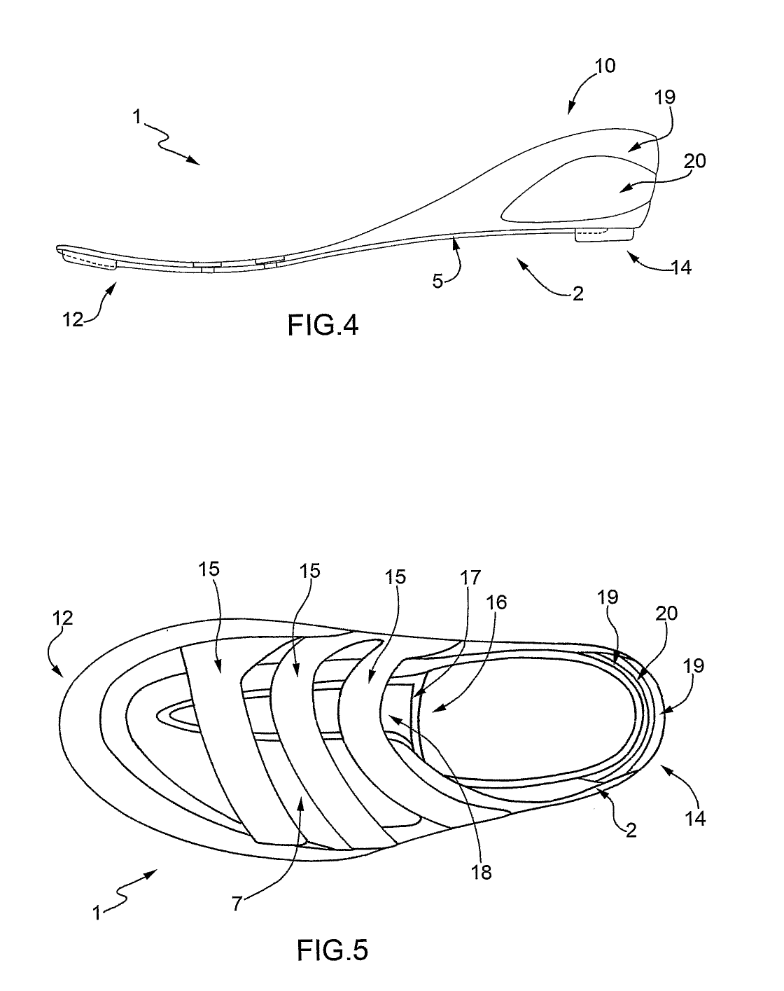

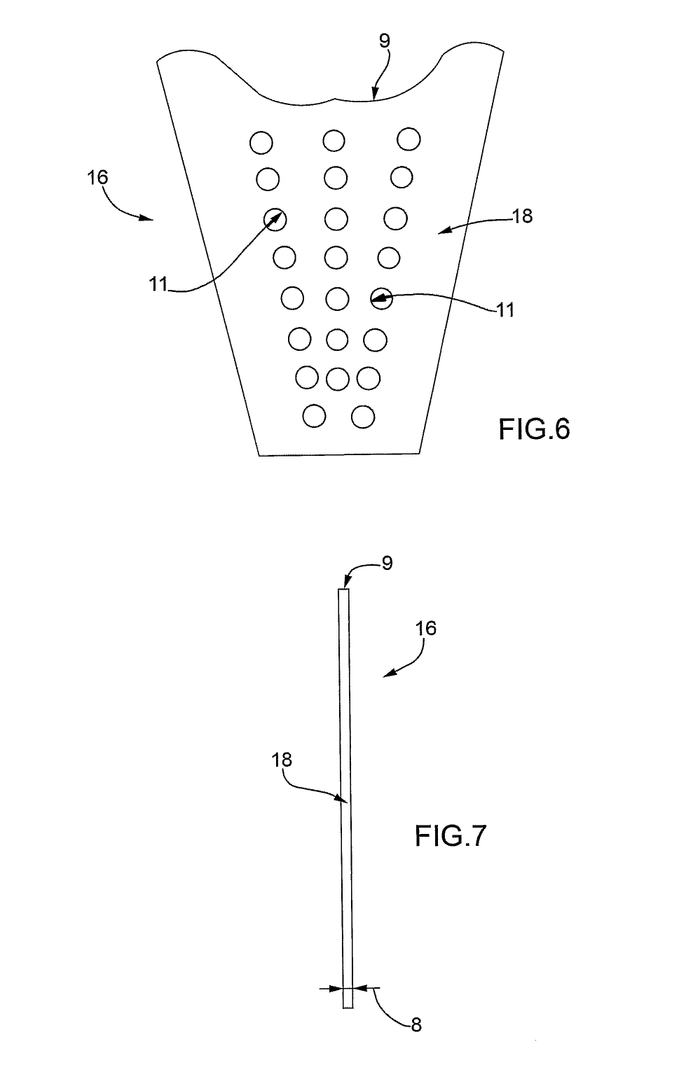

### DETAILED DESCRIPTION OF PREFERRED EMBODIMENTS

With reference to the figures, a sports footwear 1 is shown, which is particularly suited for be used in bicycles and pedal vehicles of various kinds, both for road and off-road, according to the present invention.

Said footwear 1 presents an outsole 2 made of a composite material. Said composite material comprises at least a first composite material 3 with high stiffness and at least a second composite material 4 with lower stiffness.

Said outsole 2 comprises a front zone 12 and, in its rear zone 10, an anatomic heel cup 14 made in a composite material comprising at least a first material 19 with high stiffness and at least a second material 20 with lower stiffness and with flexibility characteristics. Said heel cup 14, thanks to said at least a second material 20 with lower stiffness, allows a proper fit for a wide range of different heel shapes and sizes.

Furthermore, said heel cup 14 allows a comfortable and snug fit to support and control the user's foot during athletic cycling, thanks to said at least a first material 19 with high stiffness.

The presence, in said heel cup 14, of composite material comprising at least a first composite material 19 with high stiffness and at least a second composite material 20 with lower stiffness creates a wrapper for the user's heel with differential stiffness able to accommodate the heel at the time of entry of the feet in said footwear 1. This is obtained through the elasticity and extensibility of said at least a second composite material 20. At the same time, once the user's feet is entered into said footwear 1, said at least a first material 19 with high stiffness allows containment of the user's feet in a safe and effective way. The user's foot, therefore, is not escaping from said footwear 1 even after high pressure and/or a high number of revolutions during athletic cycling.

The at least a first composite material 3 with high stiffness and at least a second composite material 4 with lower stiffness of said outsole 2 may be the same or may be different than said at least a first composite material 19 with high stiffness and at least a second composite material 20 with lower stiffness of said heel cup 14.

Said outsole 2 comprises means with differential stiffness 5, for example in the form of a tubular element and/or a cord and/or a vein and/or ribs. Said means with differential stiffness 5 are arranged substantially along at least part of the perimeter P of said outsole 2 and present a substantially circular section 6. Said means with differential stiffness 5 may have different section shapes and may be solid or hollow and all these characteristics are under the protection of the present invention. The material of said means with differential stiffness 5 and the diameter of said section 6 provide high stiffness with said outsole 2.

Said means with differential stiffness 5 may be molded within said at least part of the perimeter P of said outsole 2 and/or attached by hand and/or through special equipment and may be manipulated at will to change the stiffness characteristics of said outsole 2. It is also possible to change the stiffness of said means with differential stiffness 5 increasing or decreasing the section 6 diameter and/or varying the materials used in their composition.

Said at least one first composite material 3 with high stiffness of said outsole 2, said at least a first composite material 19 with high stiffness of said heel cup 14 and said means with differential stiffness 5 may be made of carbon fibers linked to an epoxy matrix, and/or nylon with a carbon reinforcement and, more generally, of composite material fibers with high elasticity modulus; said at least a second composite material 4 with lower stiffness of said outsole 2 and said at least a second composite material 20 with lower stiffness of said heel cup 14 may be made of Kevlar® fibers and/or polyester and/or rubber linked to a polyurethane-based matrix and, more generally, of composite material fiber with high elongation. Said footwear 1 characteristics of high modulus and high elongation provide an anatomical and comfortable fit and, at the same time, prevent the escape of the user's foot during athletic cycling and/or efforts.

The fibers of said at least a first composite material 3 and of said at least a first composite material 19 with high stiffness could have variable orientations to obtain the maximum mechanical performance while the fibers of said at least a second composite material 4 and of said at least a second composite material 20 with lower stiffness may have a substantially longitudinal orientation with regards to the Kevlar® fibers, and a transverse orientation with regards to the polyester fibers.

In addition, there may be alternating and/or parallel orientations of the fibers in relation to one another.

The different stiffness of said outsole 2 and of said heel cup 14 may be easily illustrated by changing the fiber weave and/or color.

Said composite materials of said outsole 2 and of said heel cup 14 provide the footwear 1 with differentiated stiffness and lightness characteristics and allow customization of the elasticity and flexibility properties of both said heel cup 14 and said outsole 2.

Said footwear 1 also presents, as in FIG. 5, in its upper part 7, a fastening system 15 to the user's foot that is very narrow and rigid to prevent undesired escape of the foot from the footwear during the race or athletic cycling, especially in off-road conditions. There is also a padded tongue 16 placed below the fastening system 15. Said padded tongue 16 comprises a pocket 17 placed longitudinally or transversely in respect of the padded tongue 16 and which is suitable to contain a cushioning insert 18.

Said cushioning insert 18 may be made of ethyl-vinyl acetate (EVA) and/or gel, preferably selected from polyurethane gels, phase-change compounds, temperature-regulating compounds and other similar materials, such as the gel produced and marketed under the brand Technogel® of the same name company.

Said cushioning insert 18 allows the change of comfort degrees and the regulation of the final temperature of the user's foot.

Said cushioning insert 18 presents a thickness 8 of 2 to 4 mm in order to allow the user's fit customization inside said footwear 1 according to the volume and/or the shape of the user's foot. This permits customization of said footwear 1 fastening.

This feature is different compared to the prior art, as known padded tongues usually have a predetermined thickness and are made of ethyl-vinyl acetate (EVA) or tissue.

Said cushioning insert 18 is made of a wide variety of materials of different hardness and stiffness.

The user can decide at will to customize the cushioning insert 18 both in terms of material and thickness 8. Said cushioning insert 18 is also interchangeable to allow greater customization depending on the user's tastes and needs.

Said cushioning insert 18 has a top surface 9, which presents a variable conformation depending on the padded tongue 16 corresponding conformation and on the characteristics desired by the user.

Said cushioning insert 18 presents at least one hole 11 with a diameter of at least 5 mm. These holes 11 may be arranged in rows or may have a different disposition depending on the tastes of the user.

Preferably the distance between two rows of holes 11 is at least 10 mm.

The present invention also relates to a process of producing said footwear 1. In particular, said process allows the manufacturer to customize the production of said footwear 1 in a continuous manner and at pleasure. Said process produces said footwear 1 for all types of foot conformation (western foot, Asian foot, and the like) and all kinds of foot sizes. It is also possible, for the manufacturer, to variously match said footwear 1 structure and said outsole 2 structure with different heel cups 14.

Said process for producing footwear 1 with said outsole 2 and said heel cup 14 comprises steps of providing an outsole 2 with a first part in at least a first composite material 3 with high stiffness and a second part in at least a second composite material 4 with lower stiffness.

Said process also comprises a step of stiffening said outsole 2 through means with differential stiffness 5 that are placed substantially along at least a part of the perimeter P of said outsole 2 and a step of forming a channel placed at the bottom of said outsole 2.

Said process also comprises a step of positioning said means with differential stiffness 5 into said channel and a step of molding and/or placing said means with differential stiffness 5 into said channel.

Said process may comprise, in addition, a step of stiffening said outsole 2 through carrying out a vein and/or ribs.

Said process comprises a step of co-molding and/or co-injecting said at least a first composite material 3 with high stiffness and at least a second composite material 4 with lower stiffness of said outsole 2.

Said process for producing said footwear 1 further comprises a step of providing a heel cup 14 with a first part in at least a first composite material 19 with high stiffness and a second part in at least a second composite material 20 with lower stiffness and a step of co-molding and/or co-injecting said at least a first composite material 19 with high stiffness and at least a second composite material 20 with lower stiffness of said heel cup 14.

Said process comprises, moreover, a step of providing a padded tongue 16 comprising a pocket 17 and a step of providing a cushioning insert 18 into the pocket 17 of the padded tongue 16.

The stiffness of the means with differential stiffness 5 can be manipulated by changing the material composition, the fibers alignment and the section 6 of said means with differential stiffness 5.

The stiffness of said outsole 2 can be manipulated by changing the material composition, the fibers alignment and the section 6 of said means with differential stiffness 5.

The present invention as conceived is susceptible of numerous modifications and variants all falling within the protection field of the claims.

1. Footwear, in particular for sports, ensuring greater comfort for users and greater customization of the fit, comprising at least an outsole and a heel cup associated with said footwear wherein said outsole comprises a composite material comprising at least a first composite material with high stiffness and at least a second composite material with lower stiffness.

2. Footwear according to claim 1 in which said outsole comprises means with differential stiffness.

3. Footwear according to claim 2, in which said means with differential stiffness are placed substantially along at least a part of the perimeter (P) of said outsole.

4. Footwear according to claim 1, in which said heel cup comprises a composite material comprising at least a first composite material with high stiffness and at least a second composite material with lower stiffness.

5. Footwear according to claim 1, in which said heel cup produces a shell with differentiated stiffness for the user's heel.

6. Footwear according to claim 4, in which said at least a second composite material with lower stiffness of said heel cup allows the entry and the comfort of the user's foot.

7. Footwear according to claim 4, in which said at least a first composite material with high stiffness of said heel cup allows a snug fit for support and control the user's foot during athletic cycling.

8. Footwear according to claim 4, in which said at least a first composite material with high stiffness of said outsole, said at least a first composite material with high stiffness of said heel cup and said means with differential stiffness comprise carbon fibers linked to an epoxy matrix, nylon with carbon reinforced and/or high elasticity modulus fibers.

9. Footwear according to claim 4, in which said at least a second composite material with lower stiffness of said outsole and said at least a second composite material with lower stiffness of said heel cup comprise Kevlar® fibers, polyester, rubber, connected to a polyurethane-based matrix and/or high elongation fibers.

10. Footwear according to claim 1, in which said footwear comprises a padded tongue.

11. Footwear according to claim 10, in which said padded tongue comprises a pocket to contain a cushioning insert.

12. Footwear according to claim 11, in which said cushioning insert comprises ethyl-vinyl-acetate, gels, polyurethane gels, temperature-regulating compounds, phase-change compounds, Technogel® and the like.

13. Footwear according to claim 11, in which said cushioning insert presents a thickness of 2 to 4 mm and is customizable at will to fit different users' foot sizes and shapes.

14. Process for the production of a footwear, in particular for sports, ensuring greater comfort for users and greater customization of fit, comprising at least an outsole and a heel cup associated with said footwear, said process comprising the following steps:
providing said outsole with a first part in at least a first composite material with high stiffness, and
providing said outsole with a second part in at least a second composite material with lower stiffness.

15. Process according to claim 14, further comprising a step of stiffening said outsole through means with differential stiffness.

16. Process according to claim 14, further comprising a step of placing said means with differential stiffness substantially along at least a part of the perimeter (P) of said outsole.

17. Process according to claim 14, further comprising a step of forming a channel placed at the bottom of said outsole.

18. Process according to claim 15, further comprising a step of placing said means with differential stiffness in said channel placed at the bottom of said outsole.

19. Process according to claim 15, further comprising a step of molding and/or placing said means with differential stiffness.

20. Process according to claim 14, further comprising a step of stiffening said outsole by carrying out a vein and/or ribs.

21. Process according to claim 14, further comprising a step of co-molding and/or co-injecting said at least a first composite material with high stiffness and said at least a second composite material with lower stiffness of said outsole.

22. Process according to claim 14, further comprising the following steps:
providing said heel cup with a first part in at least a first composite material with high stiffness, and
providing said heel cup with a second part in at least a second composite material with lower stiffness.

23. Process according to claim 22, further comprising a step of co-molding and/or co-injecting said at least a first composite material with high stiffness and said at least a second composite material with lower stiffness of said heel cup.

24. Process according to claim 14, further comprising a step of providing said footwear with a padded tongue.

25. Process according to claim 14, further comprising a step of providing a cushioning insert of said padded tongue.
